(19) United States
(12) Patent Application Publication
(10) Pub. No.: US 2020/0257737 A1
(43) Pub. Date: Aug. 13, 2020

(54) DOCUMENT HANDLING

(71) Applicant: Curious AI Oy, HELSINKI (FI)

(72) Inventors: Matti HERRANEN, ESPOO (FI); Alexander ILIN, ESPOO (FI)

(21) Appl. No.: 16/784,462

(22) Filed: Feb. 7, 2020

(30) Foreign Application Priority Data
Feb. 7, 2019 (FI) 20195086

(51) Int. Cl. G06F 16/93; G06N 20/00; G06N 5/04

(52) U.S. Cl. CPC G06F 16/93; G06N 5/04; G06N 20/00

(57) ABSTRACT

Disclosed is a computer-implemented method for document handling, the method includes: receiving a document including data; applying a first model of a model system to generate at least one interpretation of the document, the interpretation including at least one label; applying a second model of a model system to determine a confidence of each of the generated at least one interpretation being correct; and selecting an interpretation based on the determined confidence. Also disclosed is a computer program product, a document handling system and a computer-implemented method for generating a model system applicable by the document handling system.

### TECHNICAL FIELD

The invention concerns in general a technical field of automated document handling.

### BACKGROUND

Machine learning methods have many applications in digital document processing, for example information extraction, document classification, or fraud detection. For such applications to work well, simple rules based on e.g. textual contents of a document are often not enough. Machine learning methods can be utilized to extract additional features and utilize them in an automatically learned fashion.

In order to train a machine learning based document processing system, training data, i.e. samples of documents, and corresponding labels are typically required. For example, in an invoice handling system, the data samples may consist of scanned invoice images, and the corresponding labels of the data the system is meant to extract from an inputted document, e.g. invoice number, reference number, total sum etc. The system is then trained in an automatic fashion to produce the labels when given the input data samples, using a suitable machine learning algorithm.

A shortcoming in this approach is that although example documents may be available, they may have not been labelled for the purpose of training the machine learning system. For example, invoices may have been archived and available, but for training a machine learning system to extract some specified data, each invoice would be required to be labelled with the data, which requires costly human labor.

Hence, there is need to develop solutions which mitigate at least in part the above described shortcomings and enable more sophisticated document handling systems.

### SUMMARY

The following presents a simplified summary in order to provide basic under-standing of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a computer implemented method, a computer program product and a document handling system for handling documents. Another objective of the invention is to present a computer-implemented method for generating a model system applicable in the document handling.

The objectives of the invention are reached by computer implemented methods, a computer program product and a document handling system as defined by the respective independent claims.

According to a first aspect, a computer-implemented method for document handling is provided, the method comprises: receiving, in a document handling system, a document comprising data; applying a first model of a model system to generate at least one interpretation of the document, the interpretation comprising at least one label; applying a second model of the model system to determine a confidence of each of the generated at least one interpretation being correct; and selecting an interpretation based on the determined confidence.

A generation of the at least one interpretation of the document may comprise: applying the first model to generate a label distribution of the document, the label distribution comprising at least one label; and selecting from the label distribution a subset of labels as the interpretation.

The first model and the second model may be generated by the method as defined above by training the model system with the at least one document input received by the document handling system.

The first model may be a machine learning based model of one of the following type: an artificial neural network, a Ladder network, a variational autoencoder, a denoising autoencoder, a recurrent neural network, a convolutional neural network, a random forest.

Moreover, the second model may be a machine learning based model of one of the following type: an artificial neural network, a Ladder network, a variational autoencoder, a denoising autoencoder, a recurrent neural network, a convolutional neural network, a random forest; or the second model may be a rule-based model.

According to a second aspect, a computer program product for document handling is provided which, when executed by at least one processor, cause a document handling system to perform the method as described above.

According to a third aspect, a document handling system is provided, the document handling system comprising: a computing unit and a model system comprising a first model and a second model; the document handling system is arranged to: receive a document comprising data; apply a first model of the model system for generating at least one interpretation of the document, the interpretation comprising a set of predetermined extracted data fields; apply a second model for determining a confidence of each of the generated at least one interpretation being correct; and select an interpretation based on the determined confidence.

The document handling system may be configured to generate the at least one interpretation of the document by: applying the first model to generate a label distribution of the document, the label distribution comprising at least one label; and selecting from the label distribution a subset of labels as the interpretation.

The first model may be a machine learning based model of one of the following type: an artificial neural network, a Ladder network, a variational autoencoder, a denoising autoencoder, a recurrent neural network, a convolutional neural network, a random forest.

Moreover, the second model may be: a machine learning based model of one of the following type: an artificial neural network, a Ladder network, a variational autoencoder, a denoising autoencoder, a recurrent neural network, a convolutional neural network, a random forest; or the second model may be a rule-based model.

According to a fourth aspect, a computer-implemented method for generating a model system comprising a first model and a second model for performing a task as defined by the method according to the first aspect above is provided, the computer-implemented method comprising: generating, with an initial set of documents, a label distribution comprising one or more labels being potential for representing data in a document received by the model system as an interpretation of the document; extracting, by the first model, a prediction for each generated label in the label distribution; determining, by evaluating the second model, a confidence for each extracted prediction; selecting from the label distribution a subset of labels as the interpretation; training (350) the first model (140, 150) with the subset of labels selected as the interpretation for generating the model system (440).

The method may be applied iteratively to the model system by inputting a document in the model system.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an environment wherein a document handling system according to an embodiment of the invention is implemented to.

FIG. 2 illustrates schematically a computer-implemented method according to an embodiment of the invention.

FIG. 3 illustrates schematically a computer-implemented method for generating a model system according to an embodiment of the invention.

FIG. 4 illustrates schematically a computing unit according to an embodiment of the invention.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

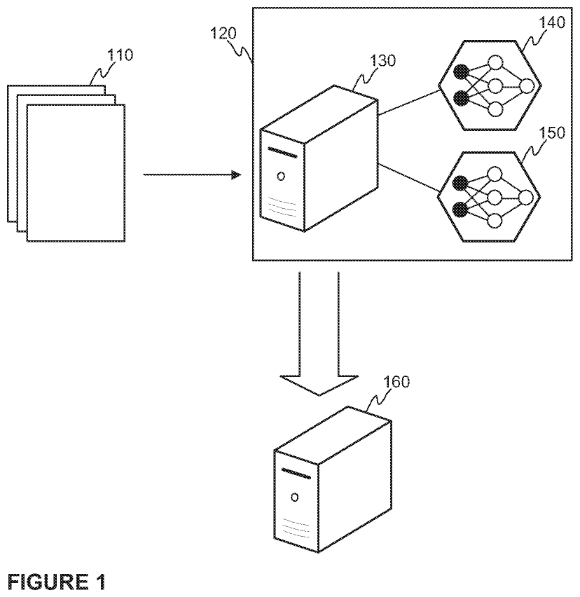

FIG. 1 illustrates schematically an environment wherein a document handling system 120 according to an embodiment of the invention is arranged to perform its tasks as will be described. The document handling system receives, as an input, one or more documents 110 in a digital form. The documents 110, i.e. the digital data representing the document, comprises information in the form of digital data by means of which certain information may be represented to a reader of the document. A non-limiting example of the information may be textual content of the document. The documents 110 processed by the document handling system 120 shall be in such a form that the document handling system may read the information therefrom, i.e. from the digital data representing the document. For example, it may be arranged that the document handling system 120 performs one or more operations to received documents in order to prepare the document into such form that the information is derivable from the document data. Such an operation may e.g. be an optical character recognition for converting image data to a machine-encoded text data. A non-limiting example of an applicable format of the document may be so-called portable document format (PDF).

More specifically, the document handling system 120 may, according to an embodiment of the invention, comprise a computing unit 130, such as a server device, and one or more models 140, 150 arranged to implement certain task. The models 140, 150 may be executed by the computing unit 130 or alternatively one or more separate processing entities, such as corresponding to the computing unit 130. The models 140, 150 may be arranged to perform their tasks in accordance with the application area, i.e. document handling in the context of the present invention.

For the purpose of the present invention a first model 140, 150 may be considered as a machine learning based model. For example, the first model 140 may be an artificial neural network, a Ladder network, a variational autoencoder, a denoising autoencoder, a recurrent neural network (such as a recurrent Ladder network, LSTM, GRU or other recurring neural network model), a convolutional neural network, a random forest, or other such machine learning component. The second model 150 may also be considered to be a machine learning based model, such as an artificial neural network, a Ladder network, a variational autoencoder, a denoising autoencoder, a recurrent neural network (such as a recurrent Ladder network, LSTM, GRU or other recurring neural network model), a convolutional neural network, a random forest, or other such machine learning component, or alternatively the second model may be a rule-based model.

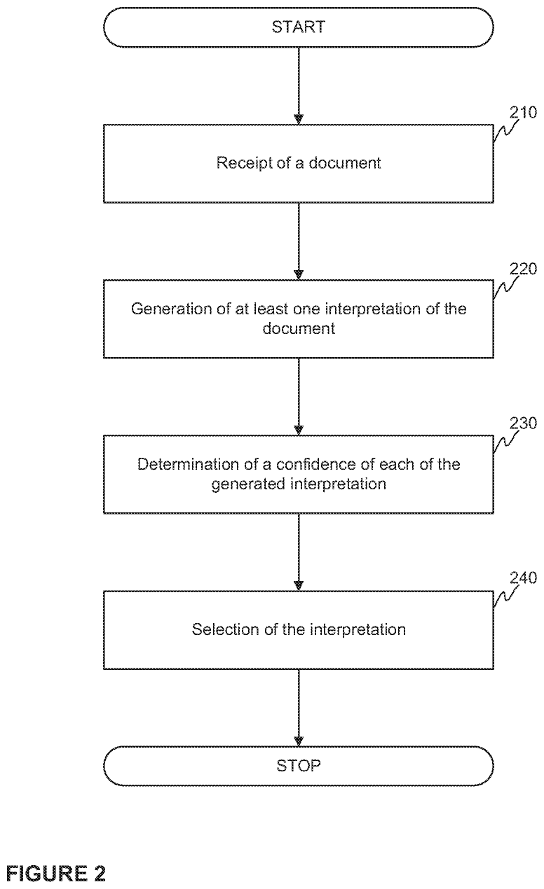

Next, at least some aspects of the invention are now described by referring to FIG. 2 illustrating schematically a method according to an embodiment of the invention. The method describes a solution for handling at least one document in accordance with the present invention and in order to derive an optimal interpretation of the data included in the document 110 with respect to data items of interest known to likely be included in the document. For example, in an application area where the documents input to the data handling system 120 are invoices, at least one aim of the extraction of the data may comprise, but is not limited to, to extract the items, i.e. labels, forming a total sum of the invoice, such as product/service 1, product/service 2, official fees, taxes and so on. In other words, a label may be considered as a piece of information that is extractable from the received document, like a total sum, line item sum of a certain category, phone number, etc. A document may have one or more labels. Labels may have a confidence value corresponding to how confident the model is in that label being correct. The confidence value may be defined during the extraction of the label. Moreover, a concept of a label distribution shall be understood to comprise a big set of all possible labels extractable from the document, e.g. for each word in the document a probability for that word being one of each possible label. Still further, the interpretation shall be understood as a set of labels selected from the label distribution. The selection may be performed based on a plausibility (confidence) of that set of labels being correct (e.g. that the numbers labelled as line items sum up to the number labelled as total sum, etc.).

Hence, a computer-implemented method according to the present invention may comprise a step of receiving 110, by a document handling system 120, a document 110 in a form of digital data. The digital data forming the document carries the information of interest from a perspective of the present invention. The document handling system 120 may be arranged to read the data and apply a first model 140, being e.g. a machine learning model, for generating at least one interpretation of the document 220. According to an embodiment of the present invention the first model 140 may be trained to perform the generation of the interpretation of the document 220 so that an outcome of the interpretation is a set of selected labels extracted from the data representing the document. The set of labels shall at least be understood to comprise the document handling system 120 generated values of the data fields. In other words, the outcome of the step 220 is either one interpretation or a plurality of interpretations as alternatives to each other.

Next, in step 230 a second model 150, being e.g. a machine learning model, is applied to the generated at least one interpretation. The second model 150 may be trained for determining a confidence of each of the generated at least one interpretation being correct. In other words, the second model 150 may be arranged to determine the confidence representing a correctness of the interpretation for each of the generated interpretations. The confidence may be determined in different ways depending on the application and the implementation of the first and second machine learning model.

The second model may be a predictive model trained to predict, given examples of correct and incorrect interpretations (sets of labels), whether an interpretation is correct. The output may be a probability that the interpretation is correct, which output may then be used as the confidence. In such case the model may be e.g. an artificial neural network, a Ladder network, a variational autoencoder, a denoising autoencoder, a recurrent neural network (such as a recurrent Ladder network, LSTM, GRU or other recurring neural network model), a convolutional neural network, a random forest, or other such machine learning component.

The second model may also be implemented, as a rule-based model, by evaluating rules or conditional statements regarding the labels, e.g. checking if numerical values are within some predetermined ranges, or whether numerical values in the labels sum up to a predetermined value, or that of another label. Such rules may be predetermined (in which case the second model may be a non-machine learning based model), or they be automatically learned from training data. The output of the second model may be a continuous confidence like a probability or a discreet value, e.g. “valid” or “not valid”.

The generation of the at least one interpretation, determining the confidence of the interpretations, and selecting the interpretation based on the determined confidence, may also be implemented as a kind of a search. This may be implemented by building up an interpretation by:
selecting at least one label from the label distribution based on the probability of the label(s),
adding the label(s) to the interpretation,
determining the confidence that the interpretation is correct by evaluating the second model and selecting or rejecting the interpretation based on the second model output. The selection/rejection may be done e.g. by
   rejecting the candidate interpretation if the confidence is below a set threshold, or in case of discrete output, “not valid”, or
   selecting the first generated interpretation where the confidence is above a set threshold, or in case of discrete output, “valid”, or
   selecting the interpretation with the largest confidence, or
   selecting the interpretation randomly and weighing the selection probabilities with the confidences of the interpretations.

Selecting the at least one label from the label distribution based on the probability of the label(s) may be done e.g. by selecting from the labels in order of decreasing probability, or randomly while weighing the selection with the label probabilities.

A number of interpretations may be generated to select from, or the first likely interpretation found can be selected.

The label distribution may be generated by evaluating the first model. Before the first model is available, e.g. it has not been trained yet, an initial label distribution may be generated by e.g. some another model, or a uniform or a random distribution may be used. The label distribution may be updated during the search procedure above based on the determined confidence of the generated interpretation, e.g. by decreasing the probability of the labels which were selected to an interpretation which was rejected.

Finally, in step 240 the document handling system 120 is arranged to select an interpretation based on the determined confidence for representing the information included in the data representing the document. In case of invoice handling the values of the interpretation may be provided to a further entity 160, such as a system or an application or a display, such as to accounting application.

In the described manner documents containing unknown data may be handled by applying the first and the second models 140, 150 to the received data representing the documents and the process as a whole may be automated at least in part.

The above described solution is at least in part based on an advantageous way of training at least the first model 140, but possibly also the second model 150. Namely, for training at least the first model existing information, also known as “weak labels”, are used in the training.

When training the models, it may occur that labels may be at least partly missing in available data, but other label data may be available. For example, in bookkeeping raw images of invoices or receipts are often archived, and some corresponding information, such as the total sum to be paid, can be found for each invoice. In a document handling system 120 according to an embodiment of the invention, such aggregate weak labels can be used in the training of a model. The term “aggregate weak label” may refer to additional data which the actual labels may be mapped to, or compared to for determining the confidence of the labels being correct, using a second model. Hence, fewer actual labels are required, or conversely a better result may be achieved with the training data available, by being able to utilize additional available information. This is often the case in e.g. accounting systems, where although the exact labels required for the training of a model are not necessarily present for at least part of the data, but other, “weaker” label information may be.

Utilizing the weak labels also makes the training of the model more robust to labelling errors, which are often present in real world data, as the weak labels are in essence used to “sanity check” the labels used in the training.

In the following it is described at least some aspects of utilizing the weak labels for checking a validity of the labels generated during the training phase.

As a starting point there is a training data, comprising of data samples x and corresponding labels y. In a context of the document handling the training data may be a set of documents which are labeled e.g. by a human operator. Here, a model, such as a machine learning model, is to be trained which produces a predicted y\hat{ } when given new input x. The given input may e.g. refer to a data item included in the document data. The following equation represents the operation of the model M 140 generating output y\hat{ } with an input x.

y\hat{ }=M(x)

Furthermore, additional “weak labels” z are to be included in the operation. Additionally, there may be a second model G 150 which may be used for evaluating a confidence, i.e. a likelihood of a correctness, that y are correct, when given y and z, confidence =G(y, z). For sake of clarity it is worthwhile to mention that some other way of determining the confidence of y being correct, given z, may be used.

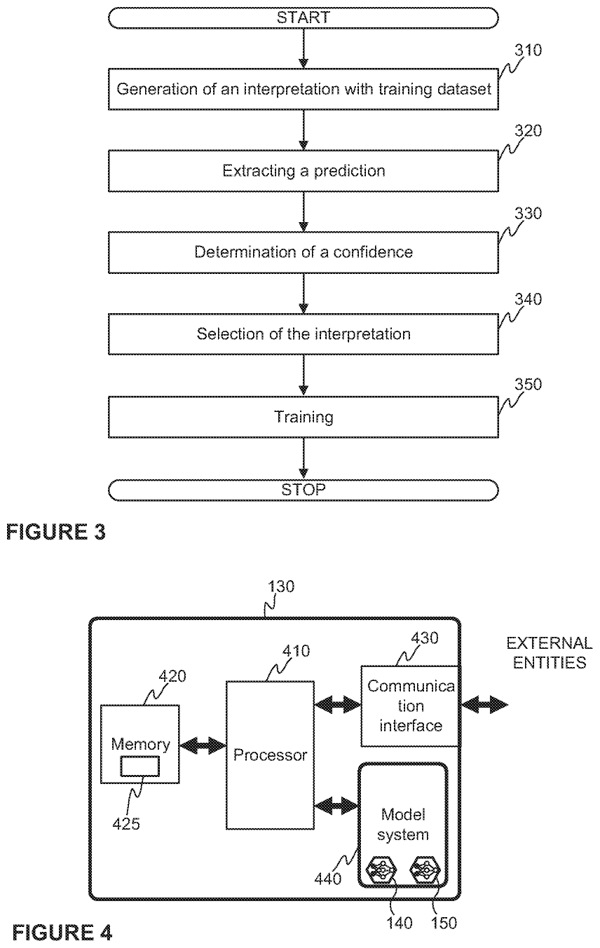

The training of the model system may be started iteratively, starting with data x and aggregate labels z. FIG. 3 illustrates schematically an example for generating a model system 440 through training. Hence, the training phase may be described as follows:
1. Generate 310 sets of potential labels (i.e. label distribution) with an initial set of documents (i.e. with a training dataset) as one or more interpretation of a document received by the model system:
   a. Extract 320 a potential prediction of the labels y\hat{ }_i from x, by:
      i. using an existing version of the model M: y\hat{ }_i=M(x)
      ii. some other predetermined way of generating an initial set of labels, such as random initialization, a predetermined value, or using pre-existing labels y if any are available
   b. Determine 330 a confidence that the prediction y\hat{ }_i is correct, by e.g.:
      i. Evaluating an aggregate model G(y\hat{ }_i, z)
2. Select 340 the best of the potential predictions y\hat{ }i, based on the determined confidence, as an interpretation y\hat{ } of the document,
3. Train 350 model M (the first model) using the selected y\hat{ } as labels (i.e. the selected y\hat{ } as the interpretation),
4. Repeat from 1.

Above causes the first model M to improve from each iteration, and the trained model M may then be used to predict y\hat{ } corresponding to new input x. The generation of the sets of potential labels may e.g. be arrange by using so-called initial set of documents, also called as a training dataset), which is input to the model system. The training dataset may comprise one or more documents, or document data, corresponding to the task into which the model system is to be taken. With the training dataset the model system may be trained to derive sets of labels applicable in the planned use of the model system. When the initial training is performed the model system 440 gets improved when the training method is applied iteratively to the model system 440 by inputting one or more new documents in the model system 440.

Hence, the above described iterative training method may be applied in a context of an application operated by the document handling system 120 where e.g. digitalized invoices are processed for automatically extracting each line data item in an invoice. The model 140 may be trained for the extraction task. In this example, in the required training data, x may be a first data content, such as the invoice text content (e.g. text lines, words, or characters), and labels y may be a list of line items listed in the invoice. If the invoices have not been processed by hand previously, label data y is not available. However, if the total sum of each invoice is available, for example from an accounting system or bank statements, the total sums may be used as weak labels z.

In this simplified non-limiting example, the aggregate model G 150 may be a model which takes as input the line items and the total sum, and may be arranged to check whether the line items sum up to the total amount. Training of the model M then proceeds as follows:
1. Generate sets of potential labels y\hat{ } for each x:
   a. Extract a prediction of the labels y\hat{ }_i from x, by:
      i. using an existing version of the model M: y\hat{ }_i=M(x)
      ii. some other predetermined way of generating an initial set of labels, such as random initialization, a predetermined value, or using pre-existing labels y if any are available. In this simplified example, all words in the input text delimited by whitespace containing a number (e.g. digit characters only) may be considered to be an invoice line item, as a first initial guess.
   b. Determine a confidence that the prediction y\hat{ }_i is correct, by:
      i. Evaluating an aggregate model G(y\hat{ }_i, z). In this simplified example, the model may check if the line items sum up to the total amount. Line item sets which do not sum up to the total amount may be rejected as a candidate.
2. Select the best y\hat{ }_i as y\hat{ } based on the determined confidence
   a. In this simplified example, a first candidate where the listed line items sum up to the total sum may be considered as the best candidate, or some other criteria may also be used.
3. Train model M using the chosen y\hat{ } as labels
   a. After step 2 above, a generated label y\hat{ } for each x is available, and the ML model M may be trained.
4. Repeat from 1.

In the described manner it is possible to train the machine learning system for extracting the line items from invoices, or other data from other document types, in a completely automatic fashion, without requiring the training data to be labelled manually.

When the involved trainable models have been trained, the method may be used iteratively in a document handling system in the following way. In this simplified example, the input document has not been seen by the system before and the weak labels z are not available, so a prediction for the weak labels z\hat{ } may be extracted using a model, in this example model N, z\hat{ }=N(x):
1. Receipt of a document
2. Generate sets of potential labels (i.e. label distribution) as one or more interpretation of the document received by the model system:
   a. Extract a potential prediction of the labels y\hat{ }_i from x, by using the model M: y\hat{ }_i=M(x)
   b. Extract a potential prediction of the weak labels z\hat{ }_i from x, by using the model M: z\hat{ }_i=M(x)
   c. Determine a confidence that the prediction y\hat{ }_i is correct, by e.g.:
      i. Evaluating an aggregate model G(y\hat{ }_i, z\hat{ }_i)
3. Select the best of the potential predictions y\hat{ }_i based on the determined confidence, as the interpretation y\hat{ } of the document,

Repeat from 1.

This way the use of the weak labels, even when extracted from the document using a model, improve the interpretation result y\hat{ }, when the interpretation is generated iteratively as described above. Model N may be implemented in similar manner as M, or models M and N may be implemented as one model, in which case the weak labels z\hat{ } are also included in the model M output. The weak labels z\hat{ } may be extracted once, before the iterative extraction of y\hat{ }, or iteratively alongside y\hat{ }, or in an outer iteration loop.

The trainable models in the system may be retrained, or refined by further training, when the system is in use, by including new received documents in the training data. New label data may also be received and used in the retraining or refining the trainable components.

Another benefit is that the described method allows using data with only some existing labels, as the existing labels may e.g. be taken as initial guesses of the labels in the iteration, and the missing labels are generated during the iteration.

Still further benefit is that if existing labels include labelling errors, for example errors by human labelers, the system is robust to this and may replace such labels by the automatically generated labels, as guided by the aggregate model G. In this way, the described method may be though of as generating a consistent interpretation of the whole input.

As already mentioned, M and N may be any machine learning model, such as an artificial neural network, a random forest, etc.

As already mentioned, G may be a rule-based model, or a machine learning model trained with x and z as training data.

Training of G may also utilize the above described mechanism, i.e. improve the weak labels z by using some other labels in the same way as z were used to generate/improve y.

A non-limiting example of a computing unit 130 suitable for performing at least some of the tasks of the document handling system 120 according to an embodiment of the invention is schematically illustrated in FIG. 4. The computing unit 130 may comprise a processing unit 410, which may be implemented with one or more processors, or similar. The computing unit 130 may also comprise one or more memories 420 and one or more communication interfaces 430. The one or more memories 420 may be configured to store computer program code 425 and any other data, which, when executed by the processing unit 410, cause the document handling system 120 to operate in the manner as described. The mentioned entities may be communicatively coupled to each other e.g. with a data bus. The communication interface 430, in turn, comprises necessary hardware and software for providing an interface for external entities for transmitting signals to and from the computing unit 130. In the exemplifying non-limiting embodiment of the computing unit 130 the computing unit 130 comprises an internal model system 440 comprising a number of models, such as 140 and 150, by means of which the tasks as described may be performed. In the example of FIG. 3 the model system 440 is arranged to operate under control of the processing unit 410. In some other embodiment of the present invention the model system 440, at least in part, may reside in another entity than the computing unit 130, as schematically illustrated in FIG. 1. In such an implementation the communication between the processing unit 410 and the model system 440 may be performed over the communication interface 430 with an applicable communication protocol. Furthermore, in some other embodiment the processing unit 410 may be configured to implement the functionality of the machine learning system and there is not necessarily arranged a separate entity as the model system 440. Still further, the models 140, 150 may both be machine learning models. On the other hand, as discussed, the second model may alternatively be implemented as a rule-based model.

Furthermore, some aspects of the present invention may relate to a computer program product comprising at least one computer-readable non-transitory medium having computer-executable program code instructions stored therein that cause, when the computer program product is executed on a computer, such as by a processing unit 410 of the computing unit 130, the handling of at least one document according to the method as described.

The specific examples provided in the description given above should not be construed as limiting the applicability and/or the interpretation of the appended claims. Lists and groups of examples provided in the description given above are not exhaustive unless otherwise explicitly stated.

1. A computer-implemented method for document handling, the method comprises:
receiving, in a document handling system, a document comprising data,
applying a first model of a model system to generate at least one interpretation of the document, the interpretation comprising at least one label,
applying a second model of the model system to determine a confidence of each of the generated at least one interpretation being correct, and
selecting an interpretation based on the determined confidence.

2. The computer-implemented method of claim 1, wherein a generation of the at least one interpretation of the document comprises:
applying the first model to generate a label distribution of the document, the label distribution comprising at least one label, and
selecting from the label distribution a subset of labels as the interpretation.

3. The computer-implemented method of claim 1, wherein the first model and the second model is generated by the method by training the model system with the at least one document input received by the document handling system.

4. The computer implemented method of claim 1, wherein the first model is a machine learning based model of one of the following type: an artificial neural network, a Ladder network, a variational autoencoder, a denoising autoencoder, a recurrent neural network, a convolutional neural network, a random forest.

5. The computer implemented method of claim 1, wherein the second model is:
a machine learning based model of one of the following type:
an artificial neural network, a Ladder network, a variational autoencoder, a denoising autoencoder, a recurrent neural network, a convolutional neural network, a random forest; or
a rule-based model.

6. A non-transitory computer-readable medium on which is stored a computer program for document handling which, when executed by at least one processor, cause a document handling system to perform the method according to claim 1.

7. A document handling system comprising:
a computing unit, and
a model system comprising a first model and a second model, the document handling system is arranged to:
receive a document comprising data,
apply a first model of the model system for generating at least one interpretation of the document, the interpretation comprising a set of predetermined extracted data fields,
apply a second model for determining a confidence of each of the generated at least one interpretation being correct, and select an interpretation based on the determined confidence.

8. The document handling system of claim 7, wherein the document handling system is configured to generate the at least one interpretation of the document by:
applying the first model to generate a label distribution of the document, the label distribution comprising at least one label, and
selecting from the label distribution a subset of labels as the interpretation.

9. The document handling system of claim 7, wherein the first model is a machine learning based model of one of the following type: an artificial neural network, a Ladder network, a variational autoencoder, a denoising autoencoder, a recurrent neural network, a convolutional neural network, a random forest.

10. The document handling system of claim 7, wherein the second model is:
a machine learning based model of one of the following type:
an artificial neural network, a Ladder network, a variational autoencoder, a denoising autoencoder, a recurrent neural network, a convolutional neural network, a random forest; or
a rule-based model.

11. A computer-implemented method for generating a model system comprising a first model and a second model for performing a task as defined in claim 1, the computer-implemented method comprising:
generating, with an initial set of documents, a label distribution comprising one or more labels being potential for representing data in a document received by the model system as an interpretation of the document,
extracting, by the first model, a prediction for each generated label in the label distribution,
determining, by evaluating the second model, a confidence for each extracted prediction,
selecting (from the label distribution a subset of labels as the interpretation,
training the first model with the subset of labels selected as the interpretation for generating the model system.

12. The computer-implemented method of claim 11, wherein the method is applied iteratively to the model system by inputting a document in the model system.

13. The computer implemented method of claim 2, wherein the first model is a machine learning based model of one of the following type: an artificial neural network, a Ladder network, a variational autoencoder, a denoising autoencoder, a recurrent neural network, a convolutional neural network, a random forest.

14. The computer implemented method of claim 3, wherein the first model is a machine learning based model of one of the following type: an artificial neural network, a Ladder network, a variational autoencoder, a denoising autoencoder, a recurrent neural network, a convolutional neural network, a random forest.

15. The computer implemented method of claim 2, wherein the second model is:
a machine learning based model of one of the following type:
an artificial neural network, a Ladder network, a variational autoencoder, a denoising autoencoder, a recurrent neural network, a convolutional neural network, a random forest; or
a rule-based model.

16. The computer implemented method of claim 3, wherein the second model is:
a machine learning based model of one of the following type:
an artificial neural network, a Ladder network, a variational autoencoder, a denoising autoencoder, a recurrent neural network, a convolutional neural network, a random forest; or
a rule-based model.

17. The computer implemented method of claim 4, wherein the second model is:
a machine learning based model of one of the following type:
an artificial neural network, a Ladder network, a variational autoencoder, a denoising autoencoder, a recurrent neural network, a convolutional neural network, a random forest; or
a rule-based model.

18. A non-transitory computer-readable medium on which is stored a computer program for document handling which, when executed by at least one processor, cause a document handling system to perform the method according to claim 2.

19. A non-transitory computer-readable medium on which is stored a computer program for document handling which, when executed by at least one processor, cause a document handling system to perform the method according to claim 3.

20. A non-transitory computer-readable medium on which is stored a computer program for document handling which, when executed by at least one processor, cause a document handling system to perform the method according to claim 4.
